(19) United States
(12) Patent Application Publication
(10) Pub. No.: US 2024/0430016 A1
(43) Pub. Date: Dec. 26, 2024

(54) Digital Signal Alignment Tool for Single Frequency Network Broadcasts

(71) Applicant: iBiquity Digital Corporation, Columbia, MD (US)

(72) Inventors: Jeffrey S. Baird, Calabasas, CA (US); Paul J. Peyla, Calabasas, CA (US)

(21) Appl. No.: 18/754,646

(22) Filed: Jun. 26, 2024

Related U.S. Application Data
(60) Provisional application No. 63/510,192, filed on Jun. 26, 2023.

(51) Int. Cl. H04B 17/10; H04B 17/12; H04B 17/364

(52) U.S. Cl. CPC H04B 17/104; H04B 17/12; H04B 17/364

(57) ABSTRACT

Aspects of the disclosed technology include methods, apparatus and systems that allow for measurement of the delay between main and booster digital signals within transition regions of SFNs. These measurements may be used in the design and implementation of an SFN by allowing for correction of the delay between the main and booster transmitters, thereby reducing or eliminating potential co-channel interference.

### CROSS REFERENCE TO RELATED APPLICATIONS

The present application claims the benefit of the filing date of U.S. Provisional Patent Application No. 63/510,192, filed on Jun. 26, 2023, the disclosure of which is hereby incorporated herein by reference.

### BACKGROUND

An FM HD Radio™ single-frequency network (SFN) is comprised of an FM HD Radio signal from a main transmitter and one or more FM HD Radio signals from geographically separated booster transmitters, all of which are intended to carry identical programming on the same carrier frequency. Boosters are used to extend the coverage of a radio station or fill gaps in its coverage area caused by barriers to signal propagation, such as mountains. Transition regions may exist within an SFN coverage area in which the levels of the main and booster signals are similar. If there is sufficient delay in arrival at a receive antenna between main and booster digital signals within a transition region, cochannel interference will render the composite received signal undetectable, resulting in an area or region where digital reception is unavailable. During the design and implementation of an SFN, it would be helpful if broadcasters could measure (and subsequently correct) the delay between main and booster digital signals within transition regions.

### SUMMARY

Aspects of the disclosed technology include methods, apparatus and systems that allow for measurement of the delay between main and booster digital signals within transition regions of SFNs. These measurements may be used in the design and implementation of an SFN by allowing for correction of the delay between the main and booster transmitters. The methods, apparatus and systems may be implemented as a tool that allows broadcasters to measure the time difference between main and booster HD Radio digital signals on the same frequency. Broadcasters could use this information to adjust the relative time delays to sufficiently minimize cochannel interference between the main and booster digital signals, thereby restoring digital reception within transition regions.

An aspect of the disclosed technology is an apparatus for determining a timing offset between digital signals for single frequency network broadcasts. The apparatus comprises a digital receiver for detecting a first digital signal from a first digital transmitter and a second digital signal from a second digital transmitter; and a processing element that determines a first timing element associated with a demodulated first signal derived from the first digital signal and a second timing element associated with a demodulated second signal derived from the second digital signal, wherein a difference between first timing element and the second timing element is proportional to the timing offset.

In accordance with this aspect of the disclosed technology, the apparatus comprises a directional receive antenna coupled to the digital receiver, the directional receive antenna configured to detect signals transmitted by a first antenna associated with the first digital signal and by a second antenna associated with the second digital signal. Further in accordance with this aspect of the disclosed technology, the directional antenna comprises a Yagi antenna.

In accordance with this aspect of the disclosed technology, the timing offset is proportional to a delay between the first digital signal and the second digital signal. Further, the digital receiver can be an HD Radio receiver. Further still, the first digital signal and second digital signal are each received at a signal-to-noise ratio of at least 3 dB.

Further in accordance with this aspect of the disclosed technology, the processing element determines the first and second timing elements when the first and second digital signals are within 6 dB of each other. In addition, the apparatus comprises an interface coupled to the processing element, the processing element operable to display the timing offset. Further, the timing offset is used to adjust a relative time delay between the first digital signal and the second digital signal.

Further in accordance with this aspect of the disclosed technology, the apparatus comprises an input/output port coupled to the second digital transmitter and configured to cause the second digital transmitter to adjust a delay parameter based on the timing offset.

Further still in accordance with this aspect of the disclosed technology, the first and second timing elements comprise, respectively, first and second absolute layer 1 frame numbers associated with the first digital signal and the second digital signal. Further, the apparatus comprises a first block count associated with the first digital signal and a second block count associated with the second digital signal. In addition, the first block count and second block count include no gaps.

Further in accordance with this aspect of the disclosed technology, the receiver comprises a demodulator that generates the demodulated first signal or the demodulated second signal.

Another aspect of the disclosed technology is a method for determining a timing offset between digital signals for single frequency HD Radio networks. The method comprises receiving, at a receiver, a first digital signal from a main transmitter; determining a first set of timing parameters associated with data frames transmitted via the first digital signal; receiving, at the receiver, a second digital signal from a booster transmitter; determining a second set of timing parameters associated with data frames transmitted via the second digital signal, wherein the data frames transmitted via the second signal are received when the receiver synchronizes reception with the booster transmitter; and determining a time difference between transmissions from the main transmitter and booster transmitter based on the first and second set of timing parameters.

In accordance with this aspect of the disclosed technology, the first set of timing parameters comprise one or more of an Absolute Layer 1 Frame Number (ALFN), a block number, and symbol tracking information associated with the first digital signal. Further, the second set of timing parameters comprise one or more of an Absolute Layer 1 Frame Number (ALFN), a block number, and symbol tracking information associated with the second digital signal. Further still, the timing difference is proportional to a delay between the first digital signal and the second digital signal. In addition, the first digital signal and the second digital signal are associated with signals broadcast at the same frequency in the FM radio band.

Further in accordance with this aspect of the disclosed technology, the first digital signal and second digital signal are each received with a signal-to-noise ratio of at least 3 dB. Further still, the method comprises repositioning a directional antenna coupled to the receiver to receive the second digital signal. In addition, the method comprises shutting off the main or booster transmitter associated with the first digital signal. In addition, receiving, at the receiver, the second digital signal comprises receiving the second digital signal from the booster transmitter after shutting off the first digital signal associated with the main transmitter.

### BRIEF DESCRIPTION OF THE DRAWINGS

FIG. 1 illustratively depicts a system in accordance with one or more aspects of the disclosed technology.

FIG. 2 illustratively depicts a system in accordance with one or more aspects of the disclosed technology.

FIG. 3 illustratively depicts a system in accordance with one or more aspects of the disclosed technology.

FIG. 4 illustratively depicts a process in accordance with one or more aspects of the disclosed technology.

FIG. 5 illustratively depicts a processing element in accordance with one or more aspects of the disclosed technology.

### DETAILED DESCRIPTION

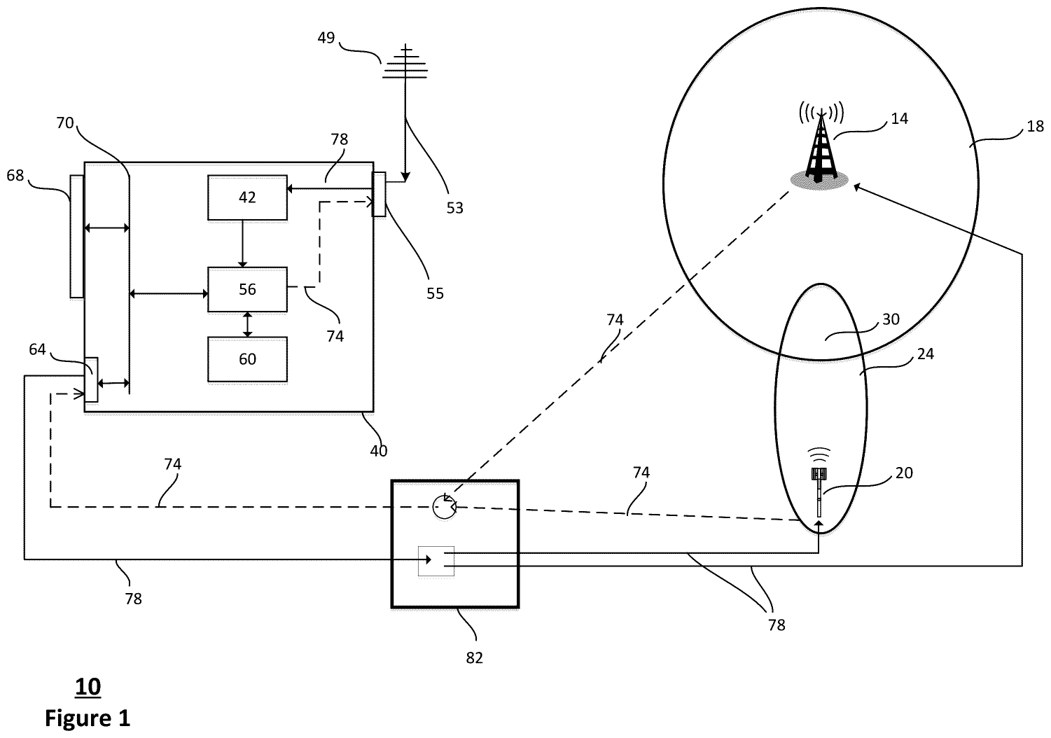

Turning now to FIG. 1, there is depicted a SFN system 10 in accordance with one or more aspects of the disclosed technology. The system 10 includes a main transmitter 14. Main transmitter 14 is depicted as an omni directional transmitter but other types of transmitters may serve as main transmitter 14. Because transmitter 14 is an omnidirectional transmitter it typically radiates its signal or power in all directions perpendicular to an axis (e.g., azimuthal directions). FIG. 1 shows a two-dimensional representation 18 of the radiation pattern extending in all directions (i.e., 360 degrees) around the antenna. In a three-dimensional view, the radiation pattern is typically depicted as doughnut-shaped with the transmitter located in the opening at the center of the doughnut. The two-dimensional representation of the radiation pattern 18 in effect defines a two-dimensional region over which the signals or power radiated by transmitter 18 extends.

The system 10 of FIG. 1 also includes a booster transmitter 20. Booster transmitter 20 is a directional transmitter but may include other types of transmitters including omnidirectional transmitters. In terms of directionality, booster transmitter is typically designed with high front-to-back ratios so as to focus radiated energy in a particular direction. As shown in FIG. 1, booster transmitter 20 provides a radiation pattern 24 that is oriented in a particular direction. Radiation pattern 24 in effect defines a region over which the radiation pattern associated with directional transmitter 20 extends. Although only one booster transmitter 20 is shown, additional booster transmitters may be deployed in association with main transmitter 14. In addition, while FIG. 1 shows one directional antenna associated with region 24, additional antennas may be deployed with booster transmitter 20 so as to form a group of directional antennas that focus the energy in region 24.

FIG. 1 also shows transition region 30. Transition regions within an SFN coverage area are regions in which the levels of the main and booster signals are similar, e.g., where the power of the digital signals from the main transmitter 14 and booster transmitter 20 are approximately equal. The power of the signals from these transmitters are approximately equal when their respective power levels are within a few dB of each other. Stated another way, co-channel interference might exist if the signals from the main and booster transmitters are within 6 dB. The transition region may be considered an interference region as cochannel interference (based on similar power levels) could render the composite received signal undetectable, resulting in an area or region where digital reception is unavailable. Region 30 more generally comprises a region where the signal levels from the main transmitter 14 and booster transmitter 20 are similar (e.g., within 6 dB of each other) and the two signals are misaligned (e.g., not synchronized). Boosters are used in the first place to fill in signal in regions where the main signal is obstructed or impaired in some way. The transition region is typically a relatively small part of the booster coverage area.

The system 10 of FIG. 1 also includes an SFN alignment tool or apparatus 40. The apparatus 40 includes a receiver 42 and a processing element 56. Receiver 42 is typically a HD radio receiver, but any receiver that is capable of receiving and demodulating signals from the radio transmitters 14, 20 can be used. The receiver 42 is coupled to an antenna 49. Antenna 49 may be coupled to the apparatus 40 via a connection element 53. Connection element 53 may comprise a cable that connects to a connector 55 on apparatus 40. Connection 55 may comprise a connector that mates with a connector at one end of the cable, e.g., a coaxial connector at the end of a coaxial cable that extends from antenna 49.

Alternatively, antenna 49 may be mounted to apparatus 40. In some examples, antenna 49 is mounted so as to allow antenna 49 to be oriented in different directions. For instance, antenna 49 may be rotatably mounted to connector 55 so that it may be oriented in the direction of a main transmitter and one or more booster transmitters. A gimbal system, for example, may be coupled to or replace connector 55 that allows antenna 49 to be oriented in the direction of main transmitter 14 or booster transmitter 20. In this way, antenna 49 may be controlled remotely and oriented in the direction of a given transmitter based on GPS location data of the transmitter. In other examples, antenna 49 may be fixably mounted to apparatus 40 and the direction of the antenna 49 may be changed by repositing apparatus 40.

Receiver 42 is also connected to a processing element 56, which is coupled to memory 60. Processing element 56 may also be coupled to an input/output port 64 and display 68 via bus 70. Input/output port 64 may be configured to receive information about the locations of the main and booster transmitters in a broadcaster's network. Such information may take the form of geo-location or GPS information as shown via path 74, which as discussed above can be used to adjust the direction in which antenna 49 is oriented. In addition, input/output port 64 may be used to provide output information, e.g., timing information, to another device or location as shown by path 78. For instance, the output information, as well as input information, may take the form of messages that are sent over a network as shown by paths 74 and 78 to a device at a broadcaster's location 82. The messages may include information about the location of the transmitters 14, 20 and delay measurements made by the apparatus 40. The network may take the form of a wide area network (e.g., the Internet, a cellular or a satellite network). In this regard, the main and booster transmitters, apparatus 40, and a device at a broadcaster's location 82 may be identified on the network using IP addresses or MAC addresses. Display 68 may provide control and output functionality associated with apparatus 40. For instance, display 68 may provide the ability to initiate measurements and otherwise display calculations and results associated with a measurement.

In operation, the SFN alignment tool 40 includes a means of effectively switching receiver 42 to detect a digital signal from one of at least two digital transmitters. This switching would be performed within transition regions, where the power of the two digital signals is approximately equal. However, a signal-to-noise ratio of approximately 3 dB or higher within the signal bandwidth would be required for either signal to be independently detected so that a timing measurement could be made. One way to isolate the signals from the main and booster transmitters 14, 20 would be to point a directional receive antenna (such as a yagi) toward the transmit antennas of interest. As such, in some cases, antenna 49 is a yagi antenna that is oriented toward the main or booster transmitter 14 or 20, while antenna 49 and, typically, apparatus 40 are located within transition region 30.

Once a sufficiently high SNR is obtained, receiver 42 could be used to detect and demodulate the digital signal and derive synchronization information used in determining the time difference or delay between the main transmitters and their associated booster transmitters. Specifically, using processing element 56, a differential analysis could then be performed between key timing elements of the demodulated main and booster digital signals that could indicate the time offset between them. Display 68 could display this timing information to allow subsequent correction of the broadcast digital signals. HMI software may be used to present a differential analysis to the broadcaster. This software could include a means of graphing and/or displaying desired, as well as key, receiver timing information. Alternatively, processing element 60 may communicate the timing information (i.e., the timing offset or delay between the main and booster transmitters) as output via input/output port 64 so to cause the delay at the booster transmitter to be automatically adjusted. Such adjustment may take place in real time (e.g., within a time constraint set by a broadcaster). As such, such adjustment may occur on the order of microseconds to minutes. And in the case of a time constraint set by a broadcaster it may be even longer, e.g., hours or a specific time period in the day (off peak hours for example).

With regard to the differential analysis, the main and booster transmitter sites should be GPS locked to allow the receiver 42 to extract the Absolute Layer 1 Frame Number (ALFN) that is embedded within the digital signal. The ALFN could be compared after switching between the main and booster signals. An analysis of the ALFNs would determine whether the digital signals were time locked within the resolution of one Layer 1 (L1) frame (approximately 1.486s).

There are 16 L1 blocks within every L1 frame, counted modulo-16. To enhance the resolution of the measured time difference between main and booster digital signals, L1 sub-framing may be extracted by examining the block count from the two digital signals. The two block counts should be continuous with no gaps or changes observed in the counting sequence when switching between the main and booster signals. An analysis of the block count will provide a resolution of 1 OFDM symbol (approximately 2.90 ms).

To further enhance resolution of the time difference between the main and booster digital signals, the symbol tracking function within the demodulator could be used. An analysis of symbol boundary movement when switching between the main and booster signals could refine the time resolution to 1 L1 sample within the receiver tracking loops (approximately 2.69 μs). This is within the resolution required for successful HD Radio digital signal synchronization. Alignment to this level would allow interference-free digital signal reception within the transition regions.

In accordance with the foregoing, the disclosed technology provides different levels of resolution as to the approximate timing difference as follows:
L1 frame (e.g., ALFN of the L1 frame)—1.5 seconds
L1 block—93 ms ( 1/16 of an ALFN)
L1 Symbol—2.9 ms (each block has 32 symbols)
L1 Sample—2.69 μs
   The above time resolution parameters relate to the following HD Radio system parameters of the HD Radio™ Air Interface Design Description Layer 1 (Version H, November 2022) specification, the disclosure of which is incorporated herein by reference:

| | | | | Computed Value |
|---|---|---|---|---|
| Parameter Name | Symbol | Units | Exact Value | (To 4 significant figures) |
| OFDM Subcarrier Spacing | Δf | Hz | 1488375/4096 | 363.4 |
| Cyclic Prefix Width | α | none | 7/128 | 5.469 × 10⁻² |
| OFDM Symbol Duration | Tₛ | s | (1 + α) / Δf = | 2.902 × 10⁻³ |
| | | | (135/128) · (4096/1488375) | |
| OFDM Symbol Rate | Rₛ | Hz | =1/Tₛ | 344.5 |
| L1 Frame Duration | T_{f} | s | 65536/44100 = 512 · Tₛ | 1.486 |
| L1 Frame Rate | R_{f} | Hz | =1 T_{f} | 6.729 × 10⁻¹ |
| L1 Block Duration | T_{b} | s | =32 · Tₛ | 9.288 × 10⁻² |
| L1 Block Rate | R_{b} | Hz | =1/T_{b} | 10.77 |
| L1 Block Pair Duration | Tₚ | S | =64 · Tₛ | 1.858 × 10⁻¹ |
| L1 Block Pair Rate | Rₚ | Hz | =1/Tₚ | 5.383 |
| Digital Diversity Delay Frames | N_{dd} | none | 3= number of L1 frames | 3 |
| | | | of diversity delay | |
| Digital Diversity Delay Time | T_{dd} | s | =N_{dd} · T_{f} | 4.458 |
| Analog Diversity Delay Time | T_{ad} | s | =3.0 · T_{f} | 4.458 |

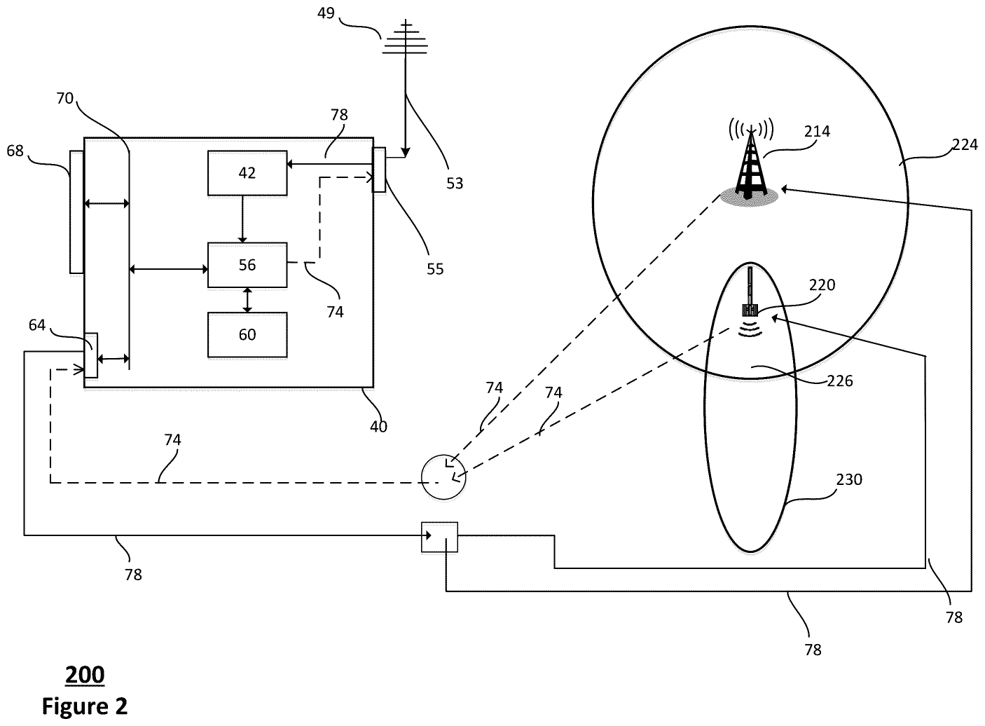

FIG. 2 provides another example of a system 200 in accordance with the disclosed technology. FIG. 2 includes similar elements as in FIG. 1 and discussions of such elements are not repeated unless necessary. System 200 includes SFN tool 40, a main transmitter 214 and booster transmitter 220. Main transmitter 214 is an omnidirectional transmitter similar to main transmitter 14 and booster transmitter 220 is similar to booster transmitter 20. As shown in FIG. 2, booster transmitter 220 is located within the transition region 226 and has coverage area 230. This is the main difference between FIGS. 1 and 2. In this regard, SFN tool 40 may be used in a similar manner described above to obtain the timing difference between the main and booster transmitters. Once the timing difference is obtained, it may be used to adjust the delay between the main transmitter (14, 214) and the booster transmitter (20, 220). For example, if it is determined that there is a delay of 5 μs between the main and booster transmitters, the broadcaster may then adjust the signals from the booster transmitter so as to eliminate delay with the transition region between the two transmitters, thereby mitigating or eliminating cochannel interference.

In this regard, in situations where a main transmitter is associated with more than one booster transmitter, adjusting the delay to align the timing between the main transmitter and a first booster transmitter may impact the delay at a second booster transmitter and cause interference between the main transmitter and the second booster transmitter in the transition region associated with the second booster. To mitigate against such situations, the SFN tool 40 may be used to determine the delay within the first transition region associated with the first booster transmitter (e.g., a first delay) and the delay within the second transition region associated with the second booster transmitter (e.g., the second delay). Based on the first and second delay, the broadcaster may then adjust, for example, the first delay so as to remedy interference in the first transition region without impacting the performance in the second transition region. In instances where adjusting the delay to address interference issues in one transition region (e.g., one where there is relative delay between the main transmitter and the booster transmitter in this region) may cause interference in another transition region (e.g., one where there is no delay between the main transmitter and the booster transmitter in this region), other solutions such as for example repositioning the booster antenna associated with the transition region may be considered. In any event, in accordance with the disclosed technology, the SFN tool 40 provides broadcasters with actual measurement data that allows them to adjust the delay or otherwise remedy cochannel interference issues associated with a given transition region.

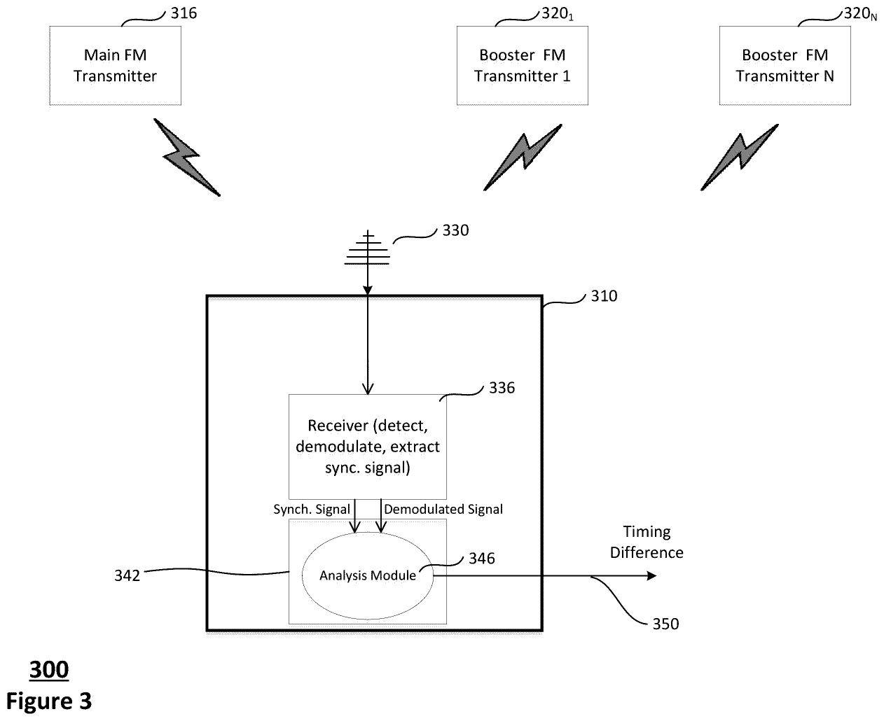

In this regard, FIG. 3 illustratively depicts a system 300 in accordance with one or more aspects of the disclosed technology. In FIG. 3, an SFN tool 310 is depicted along with a main transmitter 316 and multiple booster transmitters 3201 through 320N. The multiple booster transmitters may comprise multiple booster transmitters that form a cluster that defines a desired transition region or, alternatively, each booster transmitter may be associated with a different transition region. SFN tool 310 is coupled to directional antenna 330. Directional antenna 310 is coupled to receiver 336, which is coupled to processing element 342. Processing element 342 is shown as running analysis module 346, which outputs a timing difference signal 350. Timing difference signal 350 may be output as a signal or information that is provided to another device (such as a computer or server) over a network or may be fed to a display associated with SFN tool 310. The computer or server may be used by a broadcaster to determine the measurements made by the SFN tool 310 (or 40).

The receiver 336 is an HD Radio receiver. More generally, receiver 336 is a digital receiver that is configured to receive information transmitted using OFDM (orthogonal frequency-division multiplexing) and that includes audio content formatted using a HD Radio Codec (HDC). It includes circuitry or circuit elements for detecting and demodulating the signals received via directional antenna 330 and providing at least a synchronization signal and a demodulated signal as outputs. For example, the receiver 336 typically includes an RF tuner, and intermediate frequency filter, intermediate frequency amplifier, baseband processor (filtering, demodulation, synchronization, equalization, decoding), and audio processing. Directional antenna 330 functions to provided signals it receives from main transmitter 316 (e.g., first digital signal) and one or more booster transmitters 320 (e.g., second digital signals). In some examples, to receive the signals from the main and booster transmitters, directional antenna 330 may be repositioned so as to point in the direction of the antenna for which a measurement is desired. In other examples, after a measurement is made of the signals transmitted from the main transmitter, the main transmitter could be shut off and then measurements could be made of the booster transmitter (or vice-versa).

The analysis module 346 comprises source code or other forms of executable instructions that implement algorithms that function to determine the time difference between signals transmitted by the main transmitter 316 and booster transmitters 320. In this regard, in determining the time difference, the analysis module processes the misalignment in the synchronization data (e.g., ALFN, block number, symbol tracking information) between the first digital signal from the main transmitter 316 and a second digital signal from a second booster transmitter 320. This is performed based on the demodulated signal and synchronization signal provided by the receiver 336. More specifically, when the receiver 336 switches reception from the main transmitter 316 to a booster transmitter 320, there is a time period when the receiver 336 synchronizes with the signals from the booster transmitter 320 in which the timing of the booster transmitter data will be offset relative to the data previously received from the main antenna. It is this offset that the analysis module 346 uses to determine the timing difference between the first digital signal from the main transmitter 316 and the booster transmitter 320. The determination is made as discussed above with reference to the ALFN, block number, and symbol tracking information associated with the frame data.

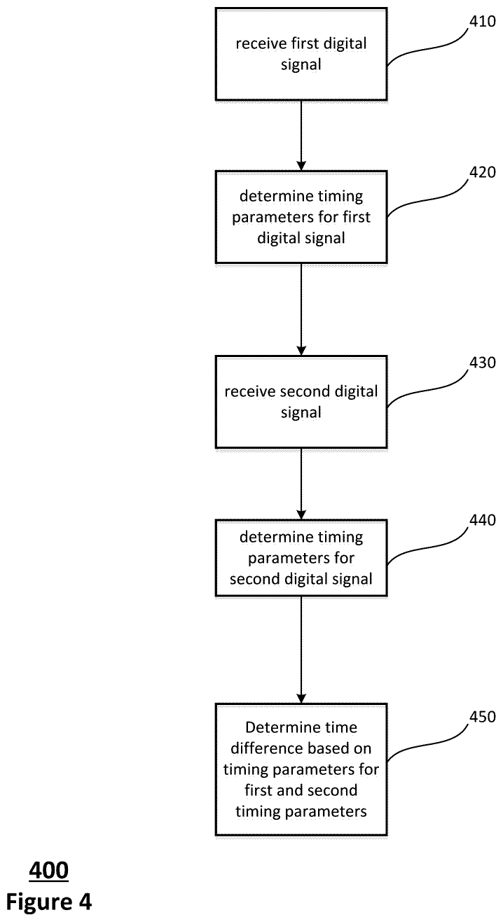

FIG. 4 illustratively depicts a process 400 in accordance with one or more aspects of the disclosed technology. The process 400 includes receiving a first digital signal, block 410. The first digital signal is received from a main transmitter associated with a transition region. At block 420, the timing parameters associated with the first digital signal are determined. The timing parameters include one or more of ALFN, block number, and symbol tracking information associated with the L1 frame. At block 430, the second digital signal is received from a booster transmitter associated with the transition region. At block 440, the timing parameters associated with second digital signal are determined. As discussed above, the timing parameters are those associated with the time period when the receiver switches to receiving the second digital signal and when it synchronizes with the booster transmitter. At block 450, the time difference between the first and second digital signals is measured using the timing parameters associated with the first and second digital signals.

The process 400 is performed by a processing element that executes source code or instructions associated with analysis module 346. In this regard, we note that SFN tool 40, 310 may be implemented using a computer, e.g., a laptop or desktop, and directional antenna.

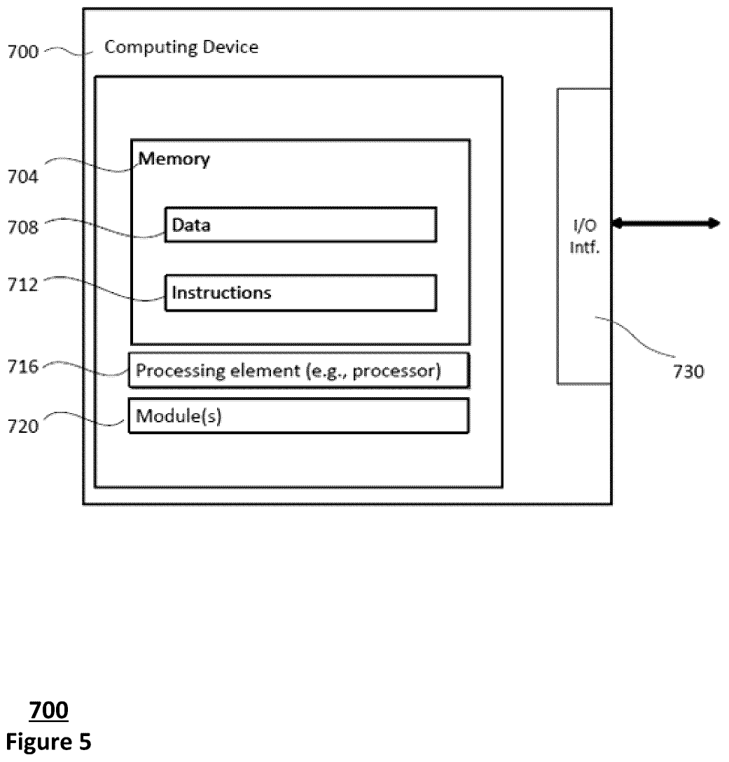

FIG. 5 depicts an example computing device 700 that may be used to carry out various aspects of the disclosed technology. For example, the computing device 700 may be used to implement the processes discussed above, including the processes and operations discussed in relation to FIGS. 1-3 and depicted in FIG. 4. Computing device 700 may also comprise apparatus 40 and 310.

The computing device 700 can take on a variety of configurations, such as, for example, a controller or microcontroller, a processor, or an ASIC. In some instances, computing device 700 may comprise a laptop, desktop, server or host machine that carries out the operations discussed above. In other instances, such operations may be performed by one or more computing devices in a data center. The computing device may include memory 704, which includes data 708 and instructions 712, and a processing element 716, as well as other components typically present in computing devices (e.g., input/output interfaces for a keyboard, display, etc., and communication ports for connecting to different types of networks).

The memory 704 can store information accessible by the processing element 716, including instructions 712 that can be executed by processing element 716. Memory 704 can also include data 708 that can be retrieved, manipulated, or stored by the processing element 716. The memory 704 may be a type of non-transitory computer-readable medium capable of storing information accessible by the processing element 716, such as a hard drive, solid state drive, tape drive, optical storage, memory card, ROM, RAM, DVD, CD-ROM, write-capable, and read-only memories. The processing element 716 can be a well-known processor or other lesser-known types of processors. Alternatively, the processing element 716 can be a dedicated controller such as an ASIC.

The instructions 712 can be a set of instructions executed directly, such as machine code, or indirectly, such as scripts, by the processor 716. In this regard, the terms “instructions,” “steps,” and “programs” can be used interchangeably herein. The instructions 712 can be stored in object code format for direct processing by the processor 716, or can be stored in other types of computer language, including scripts or collections of independent source code modules that are interpreted on demand or compiled in advance. For example, the instructions 712 may include instructions to carry out the methods and functions discussed above in relation to processing query-based document extractions.

The data 708 can be retrieved, stored, or modified by the processor 716 in accordance with the instructions 712. For instance, although the system and method are not limited by a particular data structure, the data 708 can be stored in computer registers, in a relational database as a table having a plurality of different fields and records, or in XML documents. The data 708 can also be formatted in a computer-readable format such as, but not limited to, binary values, ASCII, or Unicode. Moreover, the data 708 can include information sufficient to identify relevant information, such as numbers, descriptive text, proprietary codes, pointers, references to data stored in other memories, including other network locations, or information that is used by a function to calculate relevant data.

FIG. 5 functionally illustrates the processing element 716 and memory 704 as being within the same block, but the processing element 716 and memory 704 may instead include multiple processors and memories that may or may not be stored within the same physical housing. For example, some of the instructions 712 and data 708 may be stored on a removable CD-ROM and others may be within a read-only computer chip. Some or all of the instructions and data can be stored in a location physically remote from, yet still accessible by, the processing element 716. Similarly, the processing element 716 can include a collection of processors, which may or may not operate in parallel.

The computing device 700 may also include one or more modules 720. Modules 720 may comprise software modules that include a set of instructions, data, and other components (e.g., libraries) used to operate computing device 700 so that it performs specific tasks. For example, the modules may comprise scripts, programs, or instructions to implement one or more of the functions associated with the analysis module and process discussed in FIGS. 3 and 4. The module(s) 720 may comprise scripts, programs, or instructions to implement the process flow of FIG. 4 and the functions of the analysis module, or more generally the operations described in relation to FIGS. 1 through 4. For instance, the analysis module may comprise one or more modules that cause the apparatus 40, 310 to accept input as shown in FIGS. 1 through 3 and provide the time difference output, or the process shown in FIG. 4.

Computing device 700 may also include one or more input/output interface 730. Interface 730 may receive a query and other data (e.g., time parameters, user input) as discussed above and after processing, output a time difference. Each output port may comprise an I/O interface that communicates with local and wide area networks. In addition, the I/O port may comprise connections to a display or other device to convey results of processing.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

Although the technology herein has been described with reference to particular examples, it is to be understood that these examples are merely illustrative of the principles and applications of the disclosed technology. It is, therefore, to be understood that numerous modifications may be made to the illustrative examples and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only some but not all possible variations of the disclosed technology. Further, the same reference numbers in different drawings can identify the same or similar elements.

1. An apparatus for determining a timing offset between digital signals for single frequency network broadcasts, comprising:
a digital receiver for detecting a first digital signal from a first digital transmitter and a second digital signal from a second digital transmitter; and
a processing element that determines a first timing element associated with a demodulated first signal derived from the first digital signal and a second timing element associated with a demodulated second signal derived from the second digital signal, wherein a difference between first timing element and the second timing element is proportional to the timing offset.

2. The apparatus of claim 1, comprising a directional receive antenna coupled to the digital receiver, the directional receive antenna configured to detect signals transmitted by a first antenna associated with the first digital signal and by a second antenna associated with the second digital signal.

3. The system of claim 2, wherein the directional antenna comprises a Yagi antenna.

4. The system of claim 1, wherein the timing offset is proportional to a delay between the first digital signal and the second digital signal.

5. The system of claim 1, wherein the digital receiver is an HD Radio receiver.

6. The system of claim 1, wherein the first digital signal and second digital signal are each received at a signal-to-noise ratio of at least 3 dB.

7. The system of claim 1, wherein the processing element determines the first and second timing elements when the first and second digital signals are within 6 dB of each other.

8. The system of claim 1, comprising an interface coupled to the processing element, the processing element operable to display the timing offset.

9. The system of claim 1, wherein the timing offset is used to adjust a relative time delay between the first digital signal and the second digital signal.

10. The system of claim 1, comprising an input/output port coupled to the second digital transmitter and configured to cause the second digital transmitter to adjust a delay parameter based on the timing offset.

11. The system of claim 1, wherein the first and second timing elements comprise, respectively, first and second absolute layer 1 frame numbers associated with the first digital signal and the second digital signal.

12. The system of claim 11, comprising a first block count associated with the first digital signal and a second block count associated with the second digital signal.

13. The system of claim 12, wherein the first block count and second block count include no gaps.

14. The system of claim 1, wherein the receiver comprises a demodulator that generates the demodulated first signal or the demodulated second signal.

15. A method for determining a timing offset between digital signals for single frequency HD Radio networks, comprising:
receiving, at a receiver, a first digital signal from a main transmitter,
determining a first set of timing parameters associated with data frames transmitted via the first digital signal,
receiving, at the receiver, a second digital signal from a booster transmitter,
determining a second set of timing parameters associated with data frames transmitted via the second digital signal, wherein the data frames transmitted via the second signal are received when the receiver synchronizes reception with the booster transmitter, and
determining a time difference between transmissions from the main transmitter and booster transmitter based on the first and second set of timing parameters.

16. The method of claim 15, wherein the first set of timing parameters comprise one or more of an Absolute Layer 1 Frame Number (ALFN), a block number, and symbol tracking information associated with the first digital signal.

17. The method of claim 15, wherein the second set of timing parameters comprise one or more of an Absolute Layer 1 Frame Number (ALFN), a block number, and symbol tracking information associated with the second digital signal.

18. The method of claim 15, wherein the timing difference is proportional to a delay between the first digital signal and the second digital signal.

19. The method of claim 15, wherein the first digital signal and the second digital signal are associated with signals broadcast at the same frequency in the FM radio band.

20. The method of claim 15, wherein the first digital signal and second digital signal are each received with a signal-to-noise ratio of at least 3 dB.

21. The method of claim 15, comprising repositioning a directional antenna coupled to the receiver to receive the second digital signal.

22. Them method of claim 15, comprising shutting off the main or booster transmitter associated with the first digital signal.

23. The method of claim 22, where receiving, at the receiver, the second digital signal comprises receiving the second digital signal from the booster transmitter after shutting off the first digital signal associated with the main transmitter.
